(19) United States
(12) Patent Application Publication
(10) Pub. No.: US 2023/0339766 A1
(43) Pub. Date: Oct. 26, 2023

(54) RHO-TYPE ZEOLITE AND METHOD OF PRODUCING RHO-TYPE ZEOLITE

(71) Applicant: NGK INSULATORS, LTD., Nagoya-City (JP)

(72) Inventors: Makoto MIYAHARA, Tajimi-City (JP); Kenichi NODA, Nagoya-City (JP); Naoto KINOSHITA, Nagoya-City (JP); Ryotaro YOSHIMURA, Kasugai-City (JP)

(73) Assignee: NGK INSULATORS, LTD., Nagoya-City (JP)

(21) Appl. No.: 18/342,828

(22) Filed: Jun. 28, 2023

Related U.S. Application Data
(63) Continuation of application No. PCT/JP2022/003060, filed on Jan. 27, 2022.

(30) Foreign Application Priority Data
Feb. 10, 2021 (JP) 2021-019690

(51) Int. Cl. C01B 39/46

(52) U.S. Cl. CPC C01B 39/46; C01P 2002/78; C01P 2002/74; C01P 2004/61; C01P 2004/62; C01P 2004/64; C01P 2002/72

(57) ABSTRACT

In an RHO-type zeolite, in a case where a peak at a lattice spacing of 9.96 to 11.25 Å in a measurement using a powder X-ray diffraction method is assumed as a reference peak and an intensity of the reference peak is assumed as 100, a relative intensity of a peak at a lattice spacing of 4.59 to 4.85 Å is 150 to 300, a relative intensity of a peak at a lattice spacing of 3.55 to 3.64 Λ is 200 to 500, and a relative intensity of a peak at a lattice spacing of 2.98 to 3.06 Å is 100 to 200.

### CROSS-REFERENCE TO RELATED APPLICATIONS

The present application is a continuation application of International Application No. PCT/JP2022/003060 filed on Jan. 27, 2022, which claims priority to Japanese Patent Application No. 2021-019690 filed on Feb. 10, 2021. The contents of these applications are incorporated herein by reference in their entirety.

### TECHNICAL FIELD

The present invention relates to an RHO-type zeolite and a method of producing an RHO-type zeolite.

### BACKGROUND ART

Zeolites having various structures are well known, and an exemplary one thereof is an RHO-type zeolite. In Patent Publication No. 6631663 (Document 1) and Japanese Patent Application Laid Open Gazette No. 2020-66564 (Document 2), for example, disclosed is a method of producing an RHO-type zeolite. Specifically, in the production method disclosed in Document 1, crown ether, alkali, and water are mixed, to thereby prepare a crown ether-alkaline aqueous solution. Subsequently, the aqueous solution is added to an aluminum atom raw material solution and mixed uniformly, and then a silicon atom raw material-containing liquid is dropped therein, to thereby prepare an aqueous gel. Then, the aqueous gel is hydrothermally synthesized, and a zeolite having an RHO-type structure is thereby obtained. Further, in a practical example shown in Document 2, aluminum isopropoxide is mixed into a predetermined aqueous solution and stirred, and subsequently cesium fluoride and tetraethyl orthosilicate are mixed into the aqueous solution. After the aqueous solution is stirred, hydrogen fluoride is mixed therein and a raw material composition is thereby obtained. Then, by using the raw material composition, an RHO-type zeolite is obtained.

Various uses of zeolites, such as for separation of specific gas, adsorption of specific molecule, and the like are considered or put into practical use. Therefore, in order to expand options of zeolites having desired characteristics, a new zeolite is always required.

### SUMMARY OF THE INVENTION

The present invention is intended for an RHO-type zeolite, and it is an object of the present invention to provide a new RHO-type zeolite.

In the RHO-type zeolite according to one preferred embodiment of the present invention, in a case where a peak at a lattice spacing of 9.96 to 11.25 Å in a measurement using a powder X-ray diffraction method is assumed as a reference peak and an intensity of the reference peak is assumed as 100, a relative intensity of a peak at a lattice spacing of 4.59 to 4.85 Å is 150 to 300, a relative intensity of a peak at a lattice spacing of 3.55 to 3.64 Å is 200 to 500, and a relative intensity of a peak at a lattice spacing of 2.98 to 3.06 Å is 100 to 200.

According to the present invention, it is possible to provide a new RHO-type zeolite.

Preferably, in the RHO-type zeolite, a molar ratio of silicon/aluminum is 1 to 10.

Preferably, in the RHO-type zeolite, a molar ratio of sodium/aluminum is 0.1 to 1.

Preferably, the RHO-type zeolite is powder having an average particle diameter of 0.01 to 1 μm.

The present invention is also intended for a method of producing an RHO-type zeolite. The method of producing an RHO-type zeolite according to one preferred embodiment of the present invention includes a) mixing a sodium source, a cesium source, and a silicon source into water and stirring a mixture thereof for a predetermined time, b) mixing powder of an RHO-type zeolite as seed crystals into a solution obtained in the operation a) and stirring a mixture thereof for a predetermined time, c) mixing an aluminum source into a solution obtained in the operation b), to thereby obtain a starting material solution, and d) synthesizing powder of an RHO-type zeolite by hydrothermal synthesis using the starting material solution. In the method of producing an RHO-type zeolite of the present invention, in the starting material solution, a molar ratio of silicon/aluminum is 2 to 30, a molar ratio of sodium/aluminum is 3 to 100, a molar ratio of cesium/aluminum is 0.4 to 3, and a molar ratio of water/aluminum is 50 to 5000.

Preferably, the molar ratio of silicon/aluminum is 4 to 30, the molar ratio of sodium/aluminum is 3 to 15, the molar ratio of cesium/aluminum is 0.4 to 2, and the molar ratio of water/aluminum is 160 to 420.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a flowchart showing a flow for producing an RHO-type zeolite;

FIG. 2 is a graph showing an XRD pattern of the RHO-type zeolite; and

FIG. 3 is a graph showing another XRD pattern of the RHO-type zeolite.

### DETAILED DESCRIPTION

An X-ray diffraction (XRD) pattern obtained by a measurement using a powder X-ray diffraction method performed on a zeolite in accordance with the present invention coincides in the positions of peaks with an XRD pattern assumed from the structure of a zeolite having a structure code of “RHO” which is designated by the International Zeolite Association. Therefore, the zeolite of the present invention is an RHO-type zeolite. Though a CuKα ray is used as a radiation source of an X-ray diffraction apparatus in the measurement of the present preferred embodiment, any other type of radiation source may be used.

In an RHO-type zeolite of the present invention (hereinafter, also referred to as a “present RHO-type zeolite”), in a case where a peak at a lattice spacing of 9.96 to 11.25 Å (Angstrom) in the measurement using the powder X-ray diffraction method is assumed as a reference peak and an intensity of the reference peak is assumed as 100, a relative value of the intensity (assuming the intensity of the reference peak as 100, a relative value of the intensity is hereinafter referred to simply as a “relative intensity”) of a peak at a lattice spacing of 4.59 to 4.85 Å is 150 to 300. Further, a relative intensity of a peak at a lattice spacing of 3.55 to 3.64 Å is 200 to 500, and a relative intensity of a peak at a lattice spacing of 2.98 to 3.06 Å is 100 to 200.

The relative intensity of the peak at the lattice spacing of 4.59 to 4.85 Å is preferably 155 to 280, and more preferably 160 to 250. The relative intensity of the peak at the lattice spacing of 3.55 to 3.64 Å is preferably 220 to 480, and more preferably 250 to 450. The relative intensity of the peak at the lattice spacing of 2.98 to 3.06 Å is preferably 110 to 190, and more preferably 120 to 190.

TABLE 1

| | Lattice Spacing | Relative |
|---|---|---|
| | (Å) | Intensity |
| 1 | 9.96-11.25 | 100 |
| 2 | 5.89-6.32 | 10-55 |
| 3 | 5.13-5.44 | 10-80 |
| 4 | 4.59-4.85 | 150-300 |
| 5 | 3.90-4.10 | 30-90 |
| 6 | 3.55-3.64 | 200-500 |
| 7 | 3.27-3.46 | 100-250 |
| 8 | 2.98-3.06 | 100-200 |

The present RHO-type zeolite has, for example, X-ray diffraction (XRD) peaks shown in Table 1. Table 1 also shows a range of relative intensity of a peak at a lattice spacing other than the above-described lattice spacings. Specifically, a relative intensity of a peak at a lattice spacing of 5.89 to 6.32 Å is 10 to 55, and a relative intensity of a peak at a lattice spacing of 5.13 to 5.44 Å is 10 to 80. Further, a relative intensity of a peak at a lattice spacing of 3.90 to 4.10 Å is 30 to 90, and a relative intensity of a peak at a lattice spacing of 3.27 to 3.46 Å is 100 to 250. Furthermore, it is assumed that the relative intensity of a peak uses a height of the XRD pattern except a baseline thereof, i.e., a background noise component. The baseline in the XRD pattern can be obtained, for example, by the Sonneveld-Visser method or a spline interpolation method.

The XRD pattern of the present RHO-type zeolite which is synthesized by a production method described later is different from the XRD pattern of the RHO-type zeolite shown in Patent Publication No. 6631663 (above-described Document 1) or that shown in Japanese Patent Application Laid Open Gazette No. 2020-66564 (above-described Document 2). For example, the present RHO-type zeolite is different from the RHO-type zeolite shown in above-described Document 1 or Document 2 in that the relative intensity of the peak at the lattice spacing of 4.59 to 4.85 Å is 150 to 300, the relative intensity of the peak at the lattice spacing of 3.55 to 3.64 Å is 200 to 500, and the relative intensity of the peak at the lattice spacing of 2.98 to 3.06 Å is 100 to 200. Therefore, the present RHO-type zeolite is a new RHO-type zeolite which is different in the crystal form from the RHO-type zeolite shown in above-described Document 1 or Document 2. The present RHO-type zeolite may include a peak other than the peaks shown in Table 1. When a separation membrane is formed by using the new zeolite of the present application invention, an RHO-type zeolite membrane having an excellent orientation can be formed. Specifically, the new zeolite of the present application invention is suitable, for example, for the use of forming a separation membrane having a high permeance and an excellent separation performance.

One example of the present RHO-type zeolite is a zeolite in which atoms (T-atoms) each located at the center of an oxygen tetrahedron (TO₄) constituting the zeolite are composed of silicon (Si) and aluminum (Al). Some of the T-atoms may be replaced by any other element (gallium, titanium, vanadium, iron, zinc, tin, or the like). This makes it possible to change a pore diameter or adsorption properties. In the present RHO-type zeolite, a molar ratio of silicon/aluminum (which is a value obtained by dividing the number of moles of silicon atoms by the number of moles of aluminum atoms, and the same applies to the following) is preferably 1 to 10, and more preferably 1.5 to 4.5. This improves the hydrophilic property of the RHO-type zeolite. The molar ratio of silicon/aluminum can be measured by the EDS (energy dispersive X-ray spectroscopic analysis). By adjusting the mixing ratio of a silicon source and an aluminum source in a starting material solution described later, or the like, it is possible to adjust the silicon/aluminum ratio in the RHO-type zeolite (the same applies to the ratio of any other elements).

Typically, the present RHO-type zeolite contains sodium (Na). A molar ratio of sodium/aluminum in the RHO-type zeolite is preferably 0.1 to 1, and more preferably 0.2 to 0.8. This can stabilize the structure of the RHO-type zeolite (suppress the collapse of the crystals, or the like). It is preferable that the RHO-type zeolite should contain cesium (Cs). A molar ratio of cesium/aluminum in the RHO-type zeolite is preferably 0.1 to 0.9, and more preferably 0.15 to 0.85. The RHO-type zeolite may contain any other alkali metal such as potassium (K), rubidium (Rb), or the like. Further, some or all of the cations may be replaced by proton (H⁺) ions, ammonium (NH₄⁺) ion, or the like by ion exchange or the like.

One example of the present RHO-type zeolite is produced by not using an organic substance termed a structure-directing agent (hereinafter, also referred to as an “SDA”), and in this case, the RHO-type zeolite does not contain the SDA. In the RHO-type zeolite not containing the SDA, pores are appropriately secured. Another example of the present RHO-type zeolite is produced by using the SDA. In this case, it is preferable that after forming the RHO-type zeolite, the SDA should be almost or completely removed. As the SDA, for example, 18-crown-6-ether or the like can be used.

The present RHO-type zeolite is produced as powder. The average particle diameter of the powder of the RHO-type zeolite is, for example, 0.01 to 1 μm, and preferably 0.1 to 0.5 μm. This can stabilize the structure of the RHO-type zeolite (suppress the collapse of the crystals, or the like). The average particle diameter of the powder is, for example, a median diameter (D50) in a particle diameter distribution obtained by a laser scattering method.

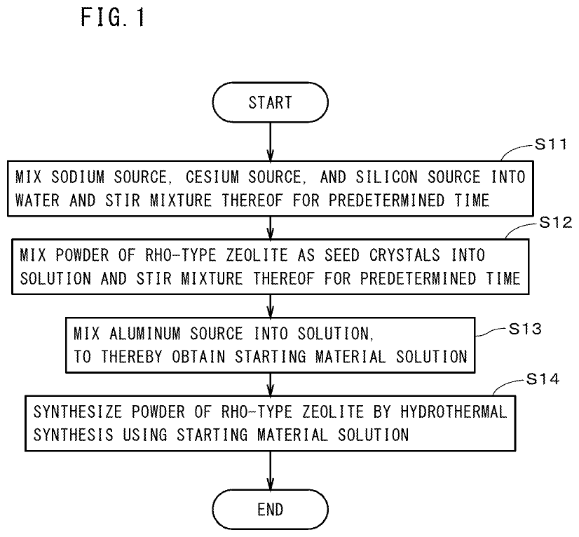

FIG. 1 is a flowchart showing a flow for producing the present RHO-type zeolite. In the present production example, first, a sodium source and a cesium source which are alkali sources are mixed into water and dissolved. The sodium source and the cesium source are also cation sources. The sodium source is, for example, sodium hydroxide, sodium chloride, sodium bromide, or the like. The cesium source is, for example, cesium hydroxide, cesium chloride, or the like. Into the solution, the SDA may be mixed. As the SDA, any one of the materials which are already exemplarily shown can be used. A silicon source is further mixed into the solution, and after that, the mixture thereof is stirred for a predetermined time (Step S11). The silicon source is, for example, colloidal silica, fumed silica, water glass, or the like. The stirring time after the alkali source and the silicon source are mixed into water is, for example, 5 hours or more, preferably 12 hours or more, and more preferably 24 hours or more. The silicon source is thereby sufficiently dissolved in the solution. The stirring time is, for example, 72 hours or less.

Subsequently, the powder of the RHO-type zeolite which is separately prepared is mixed as seed crystals into the solution and stirred for a predetermined time (Step S12). The powder of the RHO-type zeolite as the seed crystals is synthesized by a well-known production method. In the XRD pattern of the RHO-type zeolite, for example, the relative intensity of the peak at the lattice spacing of 4.59 to 4.85 Å is less than 150, the relative intensity of the peak at the lattice spacing of 3.55 to 3.64 Å is less than 200, and the relative intensity of the peak at the lattice spacing of 2.98 to 3.06 Å is less than 100. In other words, the RHO-type zeolite as the seed crystals is different from the present RHO-type zeolite. The stirring time after the seed crystals are mixed into the solution is, for example, 1 hour or more, preferably 3 hours or more, and more preferably 5 hours or more. The stirring time is, for example, 24 hours or less.

After that, the aluminum source is mixed into the solution, to thereby obtain a starting material solution (Step S13). The aluminum source is, for example, aluminum hydroxide, sodium aluminate, aluminum sulfate, or the like. In the starting material solution, the sodium source, the cesium source, the silicon source, the seed crystals, and the aluminum source are dissolved or dispersed in water. In the starting material solution, the molar ratio of silicon/aluminum is 2 to 30, and preferably 4 to 30. The molar ratio of sodium/aluminum is 3 to 100, and preferably 3 to 15. The molar ratio of cesium/aluminum is 0.4 to 3, and preferably 0.4 to 2. The molar ratio of water/aluminum is 50 to 5000, and preferably 160 to 420. A mass ratio of the seed crystals in the starting material solution is, for example, 0.0001 to 0.1, preferably 0.001 to 0.05, and more preferably 0.005 to 0.01.

Subsequently, hydrothermal synthesis of the starting material solution is performed, to thereby synthesize the powder of the RHO-type zeolite (Step S14). The temperature during the hydrothermal synthesis is, for example, 60 to 120° C. The time for hydrothermal synthesis is, for example, 1 to 60 hours. After the hydrothermal synthesis is completed, the obtained crystals are washed with pure water. Then, by drying the washed crystals, the powder of the present RHO-type zeolite is obtained. In a case where the starting material solution contains the SDA, a heat treatment is performed on the powder under an oxidizing gas atmosphere, to thereby burn and remove the SDA in the powder. Preferably, the SDA is almost completely removed. The heating temperature for removing the SDA is, for example, 350 to 700° C. The heating time is, for example, 1 to 100 hours. The oxidizing gas atmosphere is an atmosphere containing oxygen, and for example, an air atmosphere.

As described above, the production method shown in FIG. 1 includes a step of mixing a sodium source, a cesium source, and a silicon source into water and stirring a mixture thereof for a predetermined time (Step S11), a step of mixing powder of an RHO-type zeolite as seed crystals into a solution obtained in Step S11 and stirring a mixture thereof for a predetermined time (Step S12), a step of mixing an aluminum source into a solution obtained in Step S12, to thereby obtain a starting material solution (Step S13), and a step of synthesizing powder of an RHO-type zeolite by hydrothermal synthesis using the starting material solution (Step S14). In the starting material solution, the molar ratio of silicon/aluminum is 2 to 30, the molar ratio of sodium/aluminum is 3 to 100, the molar ratio of cesium/aluminum is 0.4 to 3, and the molar ratio of water/aluminum is 50 to 5000. It is thereby possible to easily produce a new RHO-type zeolite.

Herein, a production method of Comparative Examples will be described. In the production method of Comparative Examples, as shown in Document 1, after an aluminum source is mixed into a solution of alkali source, a silicon source is mixed therein and a starting material solution is thereby prepared. In this case, the silicon source becomes harder to be dissolved in the starting material solution. The same applies to the case where the alkali source and the silicon source are mixed in a solution of aluminum source and a starting material solution is thereby prepared, as shown in Document 2.

In contrast to this, in the production method of FIG. 1, the aluminum source is not mixed and the silicon source and the seed crystals are mixed in an aqueous solution of alkali source, and sufficient stirring (aging) is performed thereon. After that, by mixing the aluminum source into the mixture, a starting material solution is prepared. In this case, the silicon source and the seed crystals become easier to be dissolved, due to the alkali source. As a result, it is presumed that it becomes easier to synthesize nuclei of the RHO-type zeolite in the hydrothermal synthesis and it becomes possible to synthesize the present RHO-type zeolite having singular intensities of XRD peaks.

Next, Examples of the production of the present RHO-type zeolite will be described. Table 2 shows the composition (composition in terms of oxide) of the starting material solution prepared in each of Examples 1 to 7 and Comparative Examples 1 and 2. Table 2 also shows a Si/Al ratio, a Na/Al ratio, an average particle diameter, a synthesis temperature, and a synthesis time described later.

TABLE 2

| | | | | Average Particle | Synthesis | Synthesis |
|---|---|---|---|---|---|---|
| | | Si/Al | Na/Al | Diameter | Temperature | Time |
| | Composition | Ratio | Ratio | (μm) | (° C.) | (hr) |
| Example 1 | 9(SiO₂):1(Al₂O₃):7(Na₂O): | 3.5 | 0.5 | 0.40 | 100 | 20 |
| | 2(Cs₂O):500(H₂O) | | | | | |
| Example 2 | 10(SiO₂):1(Al₂O₃):3(Na₂O): | 4.2 | 0.6 | 0.35 | 110 | 20 |
| | 0.4(Cs₂O):2(18C6):500(H₂O) | | | | | |
| Example 3 | 22(SiO₂):1(Al₂O₃):6(Na₂O): | 3.9 | 0.3 | 0.39 | 100 | 20 |
| | 0.8(Cs₂O):330(H₂O) | | | | | |
| Example 4 | 36(SiO₂):1(Al₂O₃):15(Na₂O): | 3.5 | 0.3 | 0.39 | 100 | 20 |
| | 1.3(Cs₂O):550(H₂O) | | | | | |
| Example 5 | 54(SiO₂)):1(Al₂O₃):15(Na₂O): | 3.9 | 0.2 | 0.35 | 100 | 60 |
| | 2(Cs₂O):550(H₂O) | | | | | |
| Example 6 | 20(SiO₂):1(Al₂O₃):6(Na₂O): | 3.5 | 0.3 | 0.42 | 100 | 30 |
| | 0.8(Cs₂O):330(H₂O) | | | | | |
| Example 7 | 54(SiO₂):1(Al₂O₃):15(Na₂O): | 4.0 | 0.2 | 0.42 | 100 | 60 |
| | 2(Cs₂O):825(H₂O) | | | | | |
| Comparative | 9(SiO₂):1(Al₂O₃):7(Na₂O): | 3.0 | 0.4 | 0.45 | 100 | 20 |
| Example 1 | 2(Cs₂O):500(H₂O) | | | | | |
| Comparative | 10(SiO₂):1(Al₂O₃):0.4(Na₂O): | 4.5 | 0.5 | 0.33 | 110 | 20 |
| Example 2 | 0.1(Cs₂O):0.1(18C6):10(H₂O) | | | | | |

(Example 1) Sodium hydroxide and cesium hydroxide which are cation sources are put into water and dissolved therein. Colloidal silica which is a silicon source is put into the solution and stirred vigorously in a shaker for 24 hours. 0.3 g of powder of RHO-type zeolite as seed crystals is added to 100 g of the obtained solution and further stirred vigorously in the shaker for 2 hours. After that, aluminum hydroxide which is an aluminum source is added to the solution, to thereby prepare a starting material solution having a composition of 9 (SiO₂): 1 (Al₂O₃): 7 (Na₂O): 2 (Cs₂O): 500 (H₂O). The obtained solution is heated at 100° C. for 20 hours (the hydrothermal synthesis is performed), to thereby obtain powder of RHO-type zeolite. The obtained crystals are collected and sufficiently washed with pure water, and then dried at 120° C.

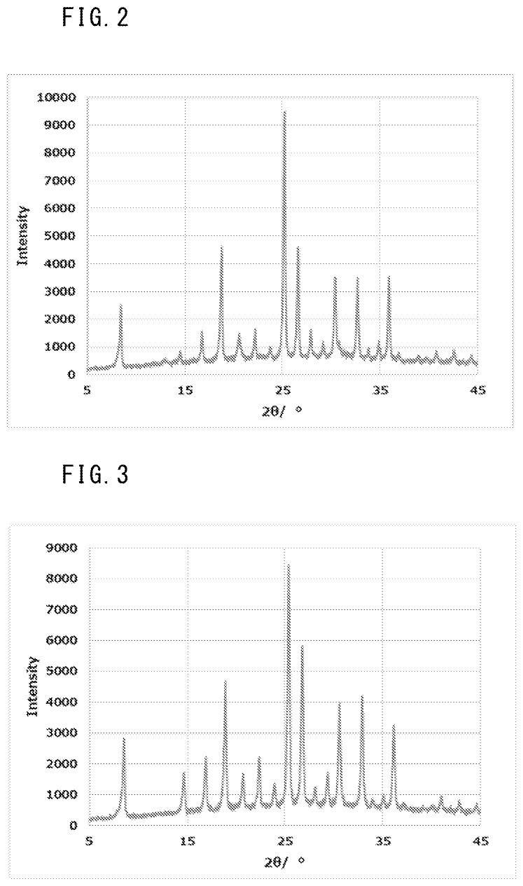

A measurement using the powder X-ray diffraction method (XRD measurement) is performed on the zeolite obtained thus. An X-ray diffraction apparatus manufactured by Rigaku Corporation (apparatus name: MiniFlex 600) is used. The powder X-ray diffraction measurement is performed with the condition that the tube voltage is 40 kV, the tube current is 15 mA, and the scanning speed is 0.5°/min, and the scanning step is 0.02°. Further, other conditions are that the divergence slit is 1.25°, the scattering slit is 1.25°, the receiving slit is 0.3 mm, the incident solar slit is 5.0°, and the light-receiving solar slit is 5.0°. No monochromator is used, and as a CuKβ ray filter, used is a nickel foil having a thickness of 0.015 mm. FIG. 2 is a graph showing an XRD pattern obtained by the XRD measurement. Table 3 shows the relative intensity of each peak in the XRD pattern.

TABLE 3

| | Lattice Spacing | 2θ | Relative |
|---|---|---|---|
| | (Å) | (º) | Intensity |
| 1 | 10.65 | 8.3 | 100 |
| 2 | 6.18 | 14.4 | 28 |
| 3 | 5.38 | 16.6 | 49 |
| 4 | 4.81 | 18.7 | 153 |
| 5 | 4.10 | 22.1 | 50 |
| 6 | 3.63 | 25.1 | 306 |
| 7 | 3.45 | 26.5 | 142 |
| 8 | 3.06 | 30.3 | 115 |

The numbers in the leftmost column of Table 3 correspond to those in the leftmost column of Table 1, respectively, (the same applies to Tables 4 to 7). In the RHO-type zeolite of Example 1, the relative intensity of the peak near 2θ=18.7° to the peak near 2θ=8.3°, i.e., the relative intensity of the peak at the lattice spacing of 4.59 to 4.85 Å is within a range from 150 to 300 (see Number 4). Further, the relative intensity of the peak near 2θ=25.1° to the peak near 2θ=8.3°, i.e., the relative intensity of the peak at the lattice spacing of 3.55 to 3.64 Å is within a range from 200 to 500 (see Number 6). Furthermore, the relative intensity of the peak near 2θ=30.3° to the peak near 2θ=8.3°, i.e., the relative intensity of the peak at the lattice spacing of 2.98 to 3.06 Å is within a range from 100 to 200 (see Number 8). Actually, the relative intensity of each peak in Table 3 is included in the range of the relative intensity shown in Table 1, and the RHO-type zeolite of Example 1 has the XRD peaks shown in Table 1.

Table 2 shows the molar ratio (Si/Al ratio) of silicon/aluminum in the RHO-type zeolite and the molar ratio (Na/Al ratio) of sodium/aluminum therein which are measured by the EDS analysis. The molar ratio of silicon/aluminum in the zeolite of Example 1 is 3.5, and the molar ratio of sodium/aluminum therein is 0.5. Further, Table 2 shows the average particle diameter of the RHO-type zeolite. The average particle diameter is a median diameter (D50) in the particle diameter distribution obtained by the laser scattering method. The average particle diameter of the zeolite in Example 1 is 0.40 μm.

(Example 2) Sodium hydroxide and cesium hydroxide which are cation sources and 18-crown-6-ether (hereinafter, also referred to as “18C6”) which is the structure-directing agent are put into water and dissolved therein. Colloidal silica which is a silicon source is put into the solution and stirred vigorously in the shaker for 24 hours. 0.3 g of the powder of the RHO-type zeolite as the seed crystals is added to 100 g of the obtained solution and further stirred vigorously in the shaker for 2 hours. After that, aluminum hydroxide which is an aluminum source is added to the solution, to thereby prepare a starting material solution having a composition of 10 (SiO₂): 1 (Al₂O₃): 3 (Na₂O): 0.4 (Cs₂O): 2 (18C6): 500 (H₂O). The obtained solution is heated at 110° C. for 20 hours, to thereby obtain powder of RHO-type zeolite. The obtained crystals are collected and sufficiently washed with pure water, and then dried at 120° C. Further, the crystals are burned at 500° C. for 10 hours in the air atmosphere, and 18-crown-6-ether is thereby removed.

When the XRD measurement is performed on the zeolite obtained thus, an XRD pattern shown in FIG. 3 is obtained. Table 4 also shows the relative intensity of each peak in the XRD pattern.

TABLE 4

| | Lattice Spacing | 2θ | Relative |
|---|---|---|---|
| | (Å) | (º) | Intensity |
| 1 | 10.35 | 8.6 | 100 |
| 2 | 6.07 | 14.7 | 50 |
| 3 | 5.29 | 16.9 | 78 |
| 4 | 4.75 | 18.9 | 165 |
| 5 | 4.05 | 22.4 | 78 |
| 6 | 3.59 | 25.4 | 298 |
| 7 | 3.42 | 26.8 | 206 |
| 8 | 3.03 | 30.6 | 141 |

In the RHO-type zeolite of Example 2, the relative intensity of the peak at the lattice spacing of 4.59 to 4.85 Å is within a range from 150 to 300 (see Number 4). Further, the relative intensity of the peak at the lattice spacing of 3.55 to 3.64 Å is within a range from 200 to 500 (see Number 6), and the relative intensity of the peak at the lattice spacing of 2.98 to 3.06 Å is within a range from 100 to 200 (see Number 8). Actually, the relative intensity of each peak in Table 4 is included in a range of the relative intensity shown in Table 1, and the RHO-type zeolite of Example 2 has the XRD peaks shown in Table 1. As shown in Table 2, the molar ratio of silicon/aluminum in the zeolite is 4.2, and the molar ratio of sodium/aluminum therein is 0.6. The average particle diameter is 0.35 μm.

(Examples 3 to 7) Examples 3 to 7 are the same as Example 1 except that the composition of the starting material solution is changed as shown in Table 2. Table 5 shows the relative intensity of each peak in the XRD pattern of the obtained zeolite. The numbers in Table 5 correspond to those in the leftmost column of Table 1, respectively. Further, Table 5 also shows the relative intensity of each peak of the zeolite in each of Examples 1 and 2 and Comparative Examples 1 and 2.

TABLE 5

| Number | 1 | 2 | 3 | 4 | 5 | 6 | 7 | 8 |
|---|---|---|---|---|---|---|---|---|
| Lattice Spacing | 9.96-11.25 | 5.89-6.32 | 5.13-5.44 | 4.59-4.85 | 3.90-4.10 | 3.55-3.64 | 3.27-3.46 | 2.98-3.06 |
| (Å) | | | | | | | | |
| Example 1 | 100 | 28 | 49 | 153 | 50 | 306 | 142 | 115 |
| Example 2 | 100 | 50 | 78 | 165 | 78 | 298 | 206 | 141 |
| Example 3 | 100 | 32 | 69 | 194 | 72 | 344 | 171 | 145 |
| Example 4 | 100 | 23 | 45 | 227 | 50 | 432 | 120 | 182 |
| Example 5 | 100 | 27 | 56 | 271 | 61 | 467 | 144 | 199 |
| Example 6 | 100 | 27 | 54 | 227 | 62 | 444 | 153 | 189 |
| Example 7 | 100 | 28 | 65 | 242 | 66 | 406 | 151 | 190 |
| Comparative | 100 | 15 | 24 | 60 | 15 | 95 | 50 | 70 |
| Example 1 | | | | | | | | |
| Comparative | 100 | 56 | 65 | 110 | 48 | 190 | 140 | 85 |
| Example 2 | | | | | | | | |

In the RHO-type zeolite of each of Examples 3 to 7, the relative intensity of the peak at the lattice spacing of 4.59 to 4.85 Å is within a range from 150 to 300 (see Number 4). Further, the relative intensity of the peak at the lattice spacing of 3.55 to 3.64 Å is within a range from 200 to 500 (see Number 6), and the relative intensity of the peak at the lattice spacing of 2.98 to 3.06 Å is within a range from 100 to 200 (see Number 8). Actually, in the RHO-type zeolite of each of Examples 3 to 7, the relative intensity of each peak is included in a range of the relative intensity shown in Table 1, and the RHO-type zeolite of each of Examples 3 to 7 has the XRD peaks shown in Table 1. Further, as shown in Table 2, the molar ratio of silicon/aluminum in the zeolite of each of Examples 3 to 7 is 3.5 to 4.0, and the molar ratio of sodium/aluminum therein is 0.2 to 0.3. The average particle diameter is 0.35 to 0.42 μm.

(Comparative Example 1) Sodium hydroxide and cesium hydroxide which are cation sources are put into water and aluminum hydroxide which is an aluminum source and colloidal silica which is a silicon source are further put into the solution and stirred vigorously in the shaker for 24 hours. A starting material solution having a composition of 9 (SiO₂): 1 (Al₂O₃): 7 (Na₂O): 2 (Cs₂O): 500 (H₂O) is thereby prepared. 0.3 g of the powder of the RHO-type zeolite as the seed crystals is added to 100 g of the obtained solution and heated at 100° C. for 20 hours, to thereby obtain powder of RHO-type zeolite.

When the XRD of the zeolite obtained thus is measured, the relative intensities of XRD peaks shown in Table 6 is obtained.

TABLE 6

| | Lattice Spacing | 2θ | Relative |
|---|---|---|---|
| | (Å) | (º) | Intensity |
| 1 | 10.67 | 8.3 | 100 |
| 2 | 6.19 | 14.4 | 15 |
| 3 | 5.39 | 16.6 | 24 |
| 4 | 4.83 | 18.6 | 60 |
| 5 | 4.09 | 22.1 | 15 |
| 6 | 3.63 | 25.1 | 95 |
| 7 | 3.44 | 26.6 | 50 |
| 8 | 3.03 | 30.6 | 70 |

In the RHO-type zeolite of Comparative Example 1, the relative intensity of the peak at the lattice spacing of 4.59 to 4.85 Å is less than 150 (see Number 4), the relative intensity of the peak at the lattice spacing of 3.55 to 3.64 Å is less than 200 (see Number 6), and the relative intensity of the peak at the lattice spacing of 2.98 to 3.06 Å is less than 100 (see Number 8). Thus, some of the relative intensities of the peaks in Table 6 are not included in the range of the relative intensity shown in Table 1, and the RHO-type zeolite of Comparative Example 1 does not have the XRD peaks shown in Table 1. As shown in Table 2, the molar ratio of silicon/aluminum in the zeolite is 3.0, and the molar ratio of sodium/aluminum therein is 0.4. The average particle diameter is 0.45 μm.

(Comparative Example 2) Sodium hydroxide and cesium hydroxide which are cation sources are put into water, 18-crown-6-ether which is the structure-directing agent is put into the solution, and aluminum hydroxide which is an aluminum source and colloidal silica which is a silicon source are further put into the solution and stirred vigorously in the shaker for 24 hours. A starting material solution having a composition of 10 (SiO₂): 1 (Al₂O₃): 0.4 (Na₂O): 0.1 (Cs₂O): 0.1 (18C6): 10 (H₂O) is thereby prepared. 0.3 g of the powder of the RHO-type zeolite as the seed crystals is added to 100 g of the obtained solution and heated at 110° C. for 20 hours, to thereby obtain powder of RHO-type zeolite. Further, the powder is burned at 500° C. for 10 hours in the air atmosphere, and 18-crown-6-ether is thereby removed.

When the XRD of the zeolite obtained thus is measured, the relative intensities of XRD peaks shown in Table 7 are obtained.

TABLE 7

| | Lattice Spacing | 2θ | Relative |
|---|---|---|---|
| | (Å) | (º) | Intensity |
| 1 | 10.50 | 8.3 | 100 |
| 2 | 6.10 | 14.5 | 56 |
| 3 | 5.30 | 16.9 | 65 |
| 4 | 4.70 | 18.6 | 110 |
| 5 | 4.00 | 22.4 | 48 |
| 6 | 3.60 | 25.2 | 190 |
| 7 | 3.40 | 26.7 | 140 |
| 8 | 3.00 | 30.6 | 85 |

In the RHO-type zeolite of Comparative Example 2, the relative intensity of the peak at the lattice spacing of 4.59 to 4.85 Å is less than 150 (see Number 4), the relative intensity of the peak at the lattice spacing of 3.55 to 3.64 Å is less than 200 (see Number 6), and the relative intensity of the peak at the lattice spacing of 2.98 to 3.06 Å is less than 100 (see Number 8). Thus, some of the relative intensities of the peaks in Table 7 are not included in the range of the relative intensity shown in Table 1, and the RHO-type zeolite of Comparative Example 2 does not have the XRD peaks shown in Table 1. As shown in Table 2, the molar ratio of silicon/aluminum in the zeolite is 4.5, and the molar ratio of sodium/aluminum therein is 0.5. The average particle diameter is 0.33 μm.

In the RHO-type zeolite and the method of producing an RHO-type zeolite described above, various modifications can be made.

The powder of the present RHO-type zeolite may be produced by any production method other than that shown in FIG. 1.

In the present RHO-type zeolite, the molar ratio of silicon/aluminum may be higher than 10. Similarly, the molar ratio of sodium/aluminum may be lower than 0.1 or higher than 1. The average particle diameter of the RHO-type zeolite may be smaller than 0.01 μm or larger than 1 μm.

The configurations in the above-described preferred embodiment and variations may be combined as appropriate only if those do not conflict with one another.

While the invention has been shown and described in detail, the foregoing description is in all aspects illustrative and not restrictive. It is therefore understood that numerous modifications and variations can be devised without departing from the scope of the invention.

### INDUSTRIAL APPLICABILITY

The RHO-type zeolite of the present invention can be used for various uses employing a zeolite.

### REFERENCE SIGNS LIST

S11 to S14 Step

1. An RHO-type zeolite, wherein
in a case where a peak at a lattice spacing of 9.96 to 11.25 Å in a measurement using a powder X-ray diffraction method is assumed as a reference peak and an intensity of said reference peak is assumed as 100, a relative intensity of a peak at a lattice spacing of 4.59 to 4.85 Å is 150 to 300, a relative intensity of a peak at a lattice spacing of 3.55 to 3.64 Å is 200 to 500, and a relative intensity of a peak at a lattice spacing of 2.98 to 3.06 Å is 100 to 200.

2. The RHO-type zeolite according to claim 1, wherein
a molar ratio of silicon/aluminum is 1 to 10.

3. The RHO-type zeolite according to claim 1, wherein
a molar ratio of sodium/aluminum is 0.1 to 1.

4. The RHO-type zeolite according to claim 1, being powder having an average particle diameter of 0.01 to 1 μm.

5. A method of producing an RHO-type zeolite, comprising:
a) mixing a sodium source, a cesium source, and a silicon source into water and stirring a mixture thereof for a predetermined time;
b) mixing powder of an RHO-type zeolite as seed crystals into a solution obtained in said operation a) and stirring a mixture thereof for a predetermined time;
c) mixing an aluminum source into a solution obtained in said operation b), to thereby obtain a starting material solution; and
d) synthesizing powder of an RHO-type zeolite by hydrothermal synthesis using said starting material solution,
wherein in said starting material solution, a molar ratio of silicon/aluminum is 2 to 30, a molar ratio of sodium/aluminum is 3 to 100, a molar ratio of cesium/aluminum is 0.4 to 3, and a molar ratio of water/aluminum is 50 to 5000.

6. The method of producing an RHO-type zeolite according to claim 5, wherein
the molar ratio of silicon/aluminum is 4 to 30, the molar ratio of sodium/aluminum is 3 to 15, the molar ratio of cesium/aluminum is 0.4 to 2, and the molar ratio of water/aluminum is 160 to 420.
